(19) United States
(12) Patent Application Publication
(10) Pub. No.: US 2009/0067437 A1
(43) Pub. Date: Mar. 12, 2009

(54) METHODS, SYSTEMS AND COMPUTER PROGRAM PRODUCTS FOR MANAGING ATM ETHERNET FLOWS

(75) Inventor: Biju Krishnan, Rohnert Park, CA (US)

Correspondence Address: FITZPATRICK CELLA (TELLABS), 30 ROCKEFELLER PLAZA, NEW YORK, NY, 10112-3800, US

(73) Assignee: TELLABS PETALUMA, INC., Naperville, IL (US)

(21) Appl. No.: 11/853,542

(22) Filed: Sep. 11, 2007

(51) Int. Cl. H04L 12/28

(52) U.S. Cl. 370/395.53

(57) ABSTRACT

Methods, systems and computer program products are provided for associating multiple Ethernet flows between a transceiver/uplink endpoint and a subscriber endpoint over an underlying ATM VCC including generating an ATM VCC record having a first endpoint identifier corresponding to a subscriber device such as a passive optical network (“PON”) or digital subscriber line (“DSL”) device and a second endpoint identifier corresponding to a transceiver card, such as a GigE card.

### BACKGROUND

1. Field

Example aspects of the present invention generally relate to network systems, and more particularly to methods, systems and computer program products for managing Asynchronous Transfer Mode (“ATM”) Ethernet flows.

2. Related Art

Asynchronous Transfer Mode (“ATM”) is a cell relay circuit, packet-switching network and data link-layer protocol which encodes data traffic into fixed-sized cells (i.e., 53 bytes cells; 48 bytes of data and 5 bytes of header information). In a conventional enterprise ATM network, all traffic that passes over the network is connection-oriented. This means that connections must be established between two endpoints before any traffic (ATM cells) can be transmitted or received. This differs from other packet-switching networks that use connectionless protocols such as the Internet Protocol (“IP”) or Ethernet which use variable sized packets, referred to sometimes as frames, and which do not provide for such ATM endpoints.

Attempts have been made to implement connection-oriented ATM networks within connectionless networks such as Ethernet. However, since the Ethernet protocol does not provide for logical ATM connections between two ATM endpoints, such a logical connection must somehow be established before an actual data exchange can begin. As the technology behind so-called “legacy” ATM systems grows older, it becomes increasingly more challenging to generate such logical connections. This is because legacy systems, such as older ATM connection-oriented systems, are not always compatible with newer network elements and require significant modification in order to establish multiple Ethernet flows between network and subscriber interfaces.

It would be useful, therefore, to provide an improved technique for implementing Ethernet connections within an ATM connection configuration. It would also be useful to provide such an implementation by leveraging existing software infrastructure to support an ATM connection configuration. It would also be useful to eliminate the additional architecture and complex implementations that have hitherto been required to implement ATM within such networks.

Some basic ATM terms are now described to facilitate understanding of the detailed description below. As mentioned above, at the core of the ATM architecture is a fixed-size “cell.” The information contained in the header of each cell is used to identify the circuit of a local link, carries local flow control information, and includes error detection to prevent cells from being misrouted. Two types of ATM connections exist: a virtual path (“VP”), which is identified by a unique 8 or 12-bit identifier in the header of an ATM cell called a virtual path identifier (“VPI”), and a virtual channel (“VC”), which is identified by the combination of a VPI and a unique 16-bit virtual channel identifier (“VCI”). A VP is a bundle of virtual channels, all of which are switched transparently across an ATM network based on a common VPI. All VPIs and VCIs, however, have only local significance across a particular link and are remapped, as appropriate, at each ATM switch in the network.

A Virtual Channel Connection (“VCC”) is a concatenation of several VC links and is the basic unit of switching in ATM, connecting two endpoints over an ATM network. A virtual path connection (“VPC”) is an aggregation of the virtual channel connections.

The VPI/VCI are used to identify the next destination of an ATM cell as it passes through the series of ATM switches on its way to its destination. Particularly, an ATM cell is received across a link on a known VPI or VCI value. The switch looks up the connection value in a local translation table to determine the outgoing port (or ports) of the connection and a new VPI/VCI value corresponding to the connection on that link. In turn, the switch retransmits the cell on that outgoing link with the appropriate connection identifiers. As mentioned above, since all VPIs and VCIs have only local significance across a particular link, these values are remapped, as necessary, at each link.

Provisioning in an ATM system is the explicit creation of a VCC in which a user specifies link endpoints and other attributes which are stored in a configuration database. A provisioned VCC is called a permanent virtual circuit (“PVC”). Once the endpoints of a connection have been provisioned, a network may automatically setup a pair of VCCs to provide bidirectional communication between the two endpoints.

Provisioning in an Ethernet system establishes connectivity services by, for example, selecting the service type (e.g., pseudo wire mesh, point-to-point circuit, VLAN VPN, and the like), providing basic information (e.g., name and customer) for the service, and defining the service parameters (e.g., capacity, traffic classification, quality of service (“QoS”) parameters, and the like). In addition, Ethernet provisioning may include selecting the end-points of the service and preparing a service configuration at the database-level and calculating configuration settings (e.g., routing, policer, access control lists, and the like). These parameters are communicated to the network elements to effect communication between, and management of, these elements.

### BRIEF DESCRIPTION

The example embodiments described herein meet the above-identified needs by providing a methods, systems and computer program products for associating multiple Ethernet flows to an ATM VCC including generating an ATM VCC record having a first endpoint identifier corresponding to a subscriber device, such as a passive optical network (“PON”) or digital subscriber line (“DSL”) device and a second endpoint identifier corresponding to a transceiver card such as an Ethernet device.

An internal register may be used to generate the second endpoint identifier and may further be used to generate a hidden VPI/VCI value. The hidden VPI/VCI value, in turn, may be hashed with user provisioning data to generate the second endpoint identifier.

An Ethernet flow data record including the first endpoint identifier, the second endpoint identifier and user provisioning data may be generated. In addition, a hidden ATM VCC entry may be stored in an ATM connection table based on the second endpoint identifier.

As part of an Ethernet device connection setup, an ATM route may be sent to the transceiver device and the subscriber device, the Ethernet flow data record may be located using the first and second endpoint identifiers, and Ethernet flow data communicated to the transceiver device.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1 depicts a system diagram of a broadband passive optical network (“BPON”) in accordance with an example embodiment of the present invention.

FIG. 2 depicts a system diagram of a digital subscriber line (“DSL”) network in accordance with an example embodiment of the present invention.

FIG. 3 depicts a process for associating multiple Ethernet flows to a hidden ATM VCC in accordance with an example embodiment of the present invention.

FIG. 4 depicts a process for setting up an ATM connection in accordance with an example embodiment of the present invention.

FIG. 5 depicts a model for associating multiple Ethernet flows to a hidden ATM VCC in accordance with an example embodiment of the present invention.

FIGS. 6a-6c are windows or screen shots generated by the graphical user interface for provisioning ATM Ethernet connections in accordance with an example embodiment of the present invention.

FIG. 7 is a collaboration diagram of functional modules deployed on a computer system for associating multiple Ethernet flows to an ATM VCC in accordance with an example embodiment of the present invention.

### DETAILED DESCRIPTION

The example embodiments of the invention presented herein are directed to methods, systems and computer program products for managing ATM Ethernet flows, which are now described herein in terms of an example broadband passive optical network (“BPON”). This description is not intended to limit the application of the example embodiments presented herein. In fact, after reading the following description, it will be apparent to one skilled in the relevant art(s) how to implement the following example embodiments in alternative embodiments involving any connection oriented system requiring a connection between an Ethernet uplink such as a GigE uplink card to either an ATM or Ethernet service endpoint.

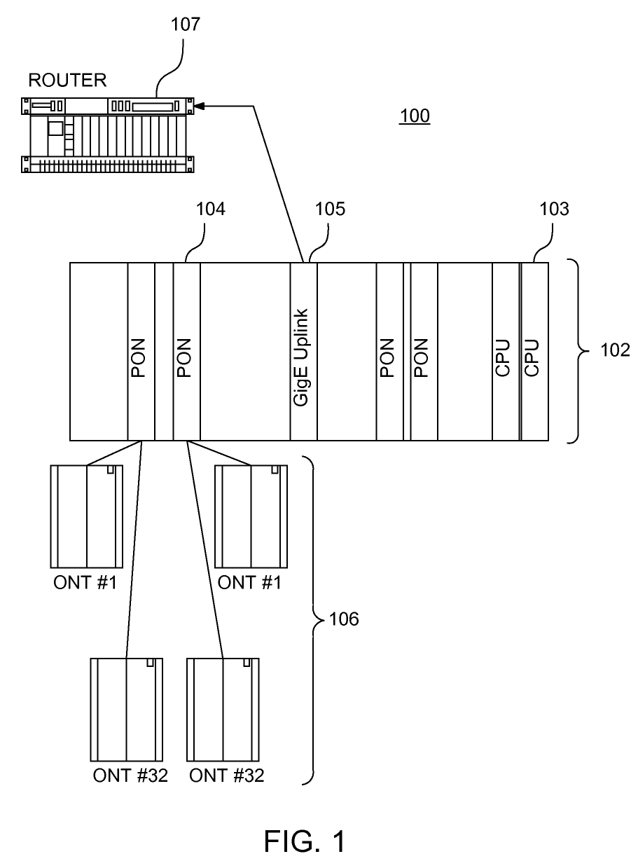

Similarly, there exist many varieties of connectionless network technologies that vary both in speed and physical medium used. The example embodiments described herein implement Gigabit Ethernet (“GigE”) which is a term describing various technologies for transmitting Ethernet packets at a rate of a gigabit per second. GigE is particularly defined by the IEEE 803.3 standard, which is incorporated herein by reference in its entirety. However, such embodiments are not limited to Ethernet technologies and can be implemented within other network technologies which do not provide for ATM endpoints (e.g., FIG. 1 depicts a system diagram of a broadband passive optical network (“BPON”) 100 in accordance with an example embodiment of the present invention. System 100 includes a central processing unit (“CPU”) card 103 communicatively coupled to a backplane bus 102. CPU 103 may be one or more computers that facilitates the transmission, storage, and reception of information between different points within network 100.

In one embodiment, CPU card 103 controls a transceiver card, such as a gigabit Ethernet (“GigE”) uplink card 105. GigE uplink card 105, in turn, may be communicatively coupled to one or more network devices, such as a router 107, via its port(s). CPU 103 also controls a line card, such as a passive optical network (“PON”) card 104 via the backplane 102. The PON card 104 may incorporate, for example, ATM communications, broadband services such as Ethernet access and video distribution, Ethernet point-to-multipoint topologies, BPON communications, GPON communications, EPON communications, and native communications of data and time division multiplex (TDM) formats, or the like.

PON card 104 may also be communicatively coupled to one or more optical network terminals (“ONTs”) 106 having an Ethernet port. Each ONT may split the resultant signals it receives into separate services required by a subscriber such as computer networking data, telephony and video (not shown). As will be explained in more detail below, to the ONT 106, PON card 104 is viewed as a subscriber endpoint.

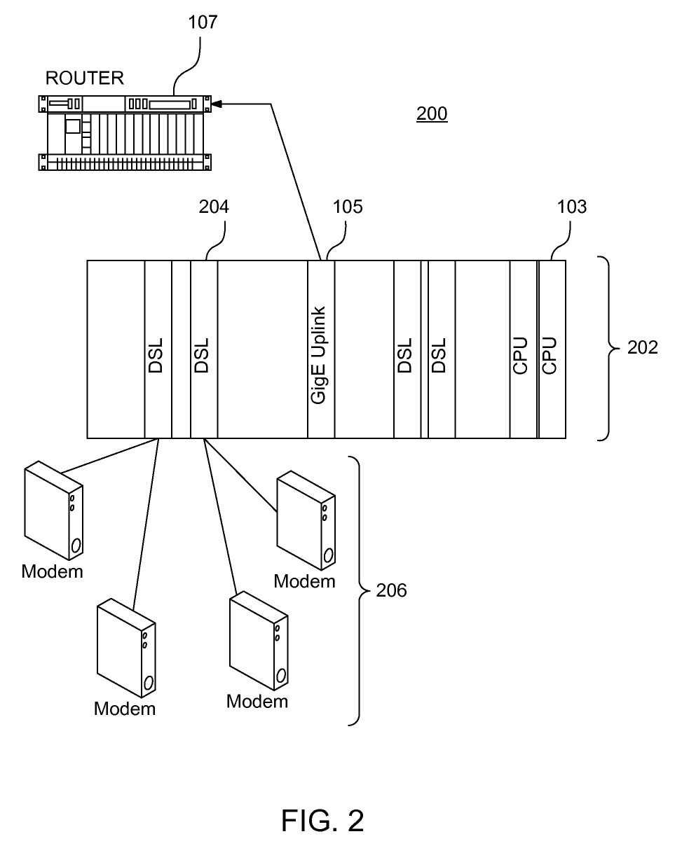

FIG. 2 depicts a system diagram of a digital subscriber line (“DSL”) network 200 in accordance with an example embodiment of the present invention. System 200 includes a central processing unit (“CPU”) card 103 communicatively coupled to a backplane bus 102. System 200 also includes a transceiver card, such as a gigabit Ethernet (“GigE”) uplink card 105, which is controlled by CPU card 103 via backplane bus 202. GigE uplink card 105 also is communicatively coupled to network devices, such as a router 107, via its port(s). A line card, such as a DSL card 204 also is communicatively coupled to backplane bus 102, and to one or more modems 206 having an Ethernet port. DSL card may be a DSL modem, asynchronous DSL (ADSL) modem, very high speed DSL (VDSL) modem, or the like. DSL card 204, like the PON card 104 described above with respect to FIG. 1, is viewed as a subscriber endpoint to the modems 206.

As explained above, system 200 is an alternative embodiment. Different network embodiments such as systems 100 and 200 can be integrated with shared components, such as GigE uplink card 105. This may be accomplished for example, by placing these components on a shared backplane. The following discussion is applicable to both example BPON and DSL systems 100 and 200, but for convenience is discussed in terms of the BPON system. Those skilled in the art will recognize that the same description is applicable to the DSL system 200 depicted in FIG. 2.

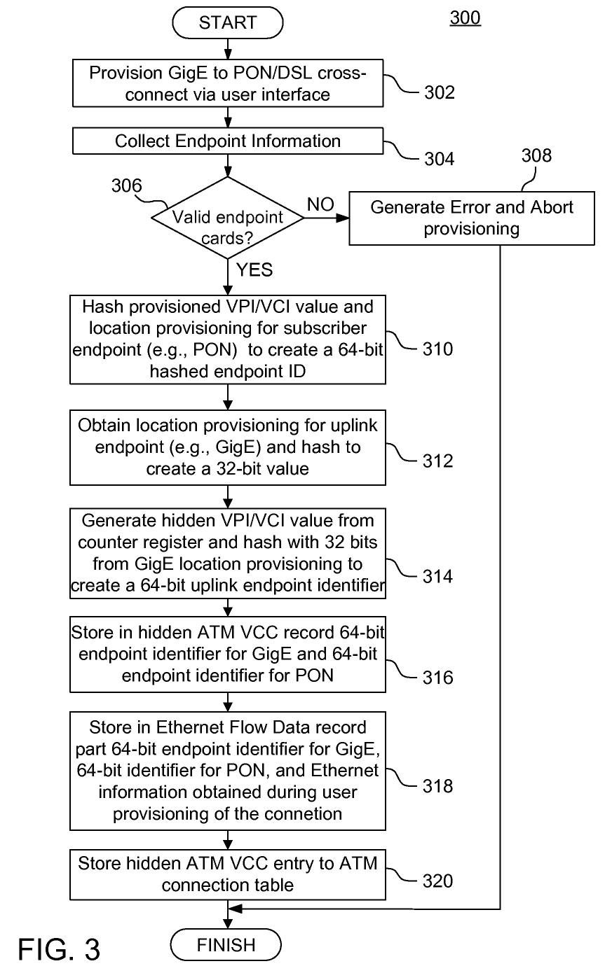

FIG. 3 depicts a process 300 for associating multiple Ethernet flows to an ATM VCC in accordance with an example embodiment of the present invention. Process 300 may be implemented in software executed by CPU 103. Generally, process 300 creates what is referred as a hidden ATM VCC record and a new database record referred to as an Ethernet flow record when a user provisions a connection to a port of a transceiver card, such as GigE uplink card 105 and a subscriber-side card, such as PON card 104. Included within the hidden ATM VCC record are two 64-bit endpoint values (e.g., uplink side and subscriber side endpoint values) and information related to ATM traffic flow, such as ATM class of service.

The Ethernet flow record uses the Ethernet parameters to manage traffic flow between a GigE uplink card 105 and a subscriber device, such as ONT 106. The Ethernet flow record includes the two 64-bit endpoint values (e.g., uplink side and subscriber side endpoint values) plus additional Ethernet information related to the Ethernet flow such as the customer-side and network-side VLAN tags and other Ethernet traffic management parameters. The Ethernet flow record uses the Ethernet parameters to manage traffic flow between a GigE uplink card 105 and a subscriber device, such as ONT 106. The Ethernet flow record may be stored in a memory device, such as a persistent flash memory or database (not shown).

Referring to FIG. 3, initially, in block 302, GigE uplink card 103 and PON card 104 are provisioned into an ATM Ethernet connection. This is performed by entering information about GigE uplink card 105 and PON card 104 through a front end, user interface connected to or executed by CPU 103. The information entered through the interface includes location provisioning, sometimes referred to as “protection group data,” which defines the location associated with the GigE uplink card 105 and PON card 104. Provisioning also includes information about the GigE uplink card 105 and subscriber PON card 104 connection information, as well as other information about the connection, such as an ATM traffic profile number representing the connection's class of service. After this information is provisioned, services on PON card 104 can be initiated.

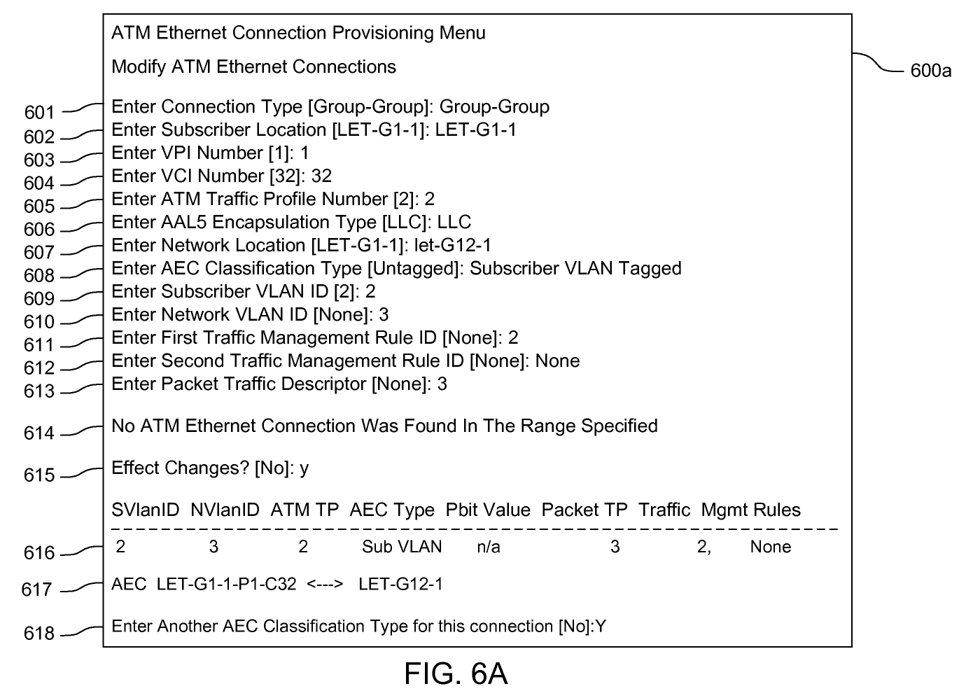

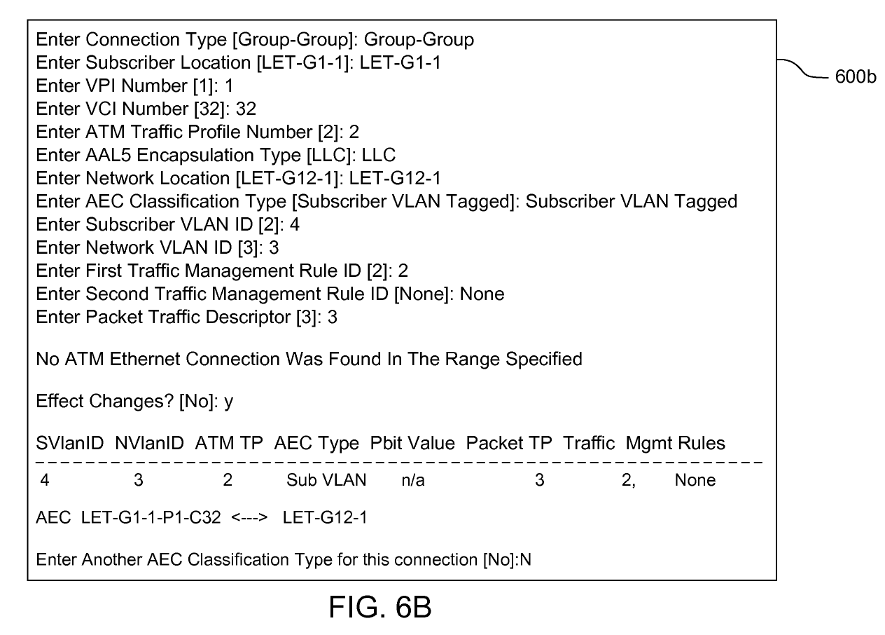

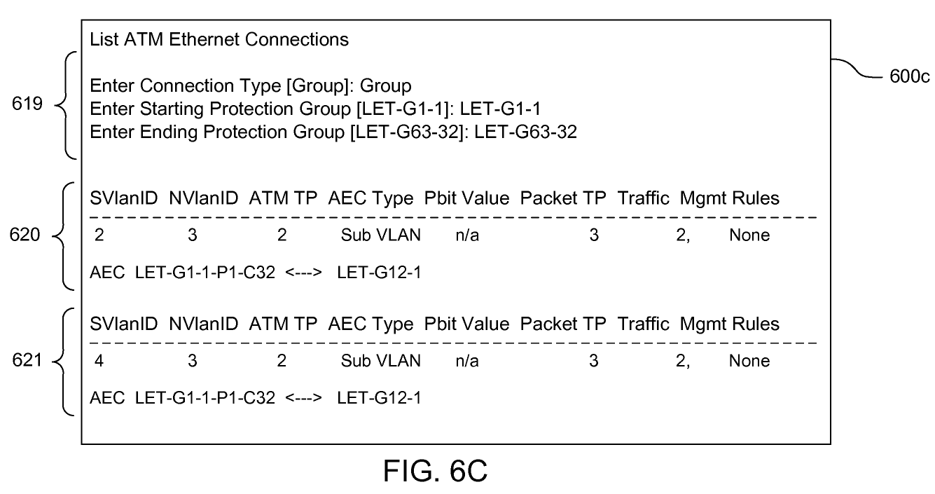

An example user interface and example provisioning information is described below with respect to FIGS. 6a-6c. Other methods of obtaining provisioning information can be used instead of using a graphical user interface (“GUI”), such as uploading preconfigured records directly to the memory device via a device or network interface. In either case, the provisioning information is collected and stored into a storage device such as a flash memory device (not shown).

The GigE endpoint is an Ethernet endpoint and thus from the perspective of a user does not include a VPI or VCI normally associated with an ATM connection. Instead, the GigE card 105 appears to the user as having an Ethernet connection to the Ethernet port of a subscriber side PON card 104. However, unlike the GigE card 105, the VPI and VCI values may be provisioned on the subscriber side PON card 104.

An Ethernet flow provisioned between the GigE uplink card 105 and the PON card 104 is associated to a VCC. The VCC is a “hidden” VCC because it is not visible by a user through, for example, a listing of VCCs. This association thus establishes a connection over the internal ATM bus 102.

In block 304, the CPU 103 reads the provisioning information and collects the physical endpoint information entered by the operator in block 302 to setup a connection between the GigE uplink card 105 and the Ethernet port of ONT 106. This physical endpoint information contains the location information for the GigE uplink and PON subscriber. In addition, an ONT port can be represented as a PON endpoint using a specific VPI/VCI corresponding to each port.

In block 306, CPU 103 validates whether the physical endpoints correspond to valid endpoint cards. If the validation check in block 306 fails, then an error signal is generated and provisioning is aborted as shown in block 308. Alternatively, provisioning is not aborted and an error message is communicated to an operator via the user interface in order to provide the user with an opportunity to re-enter a value which corresponds to a valid endpoint (not shown).

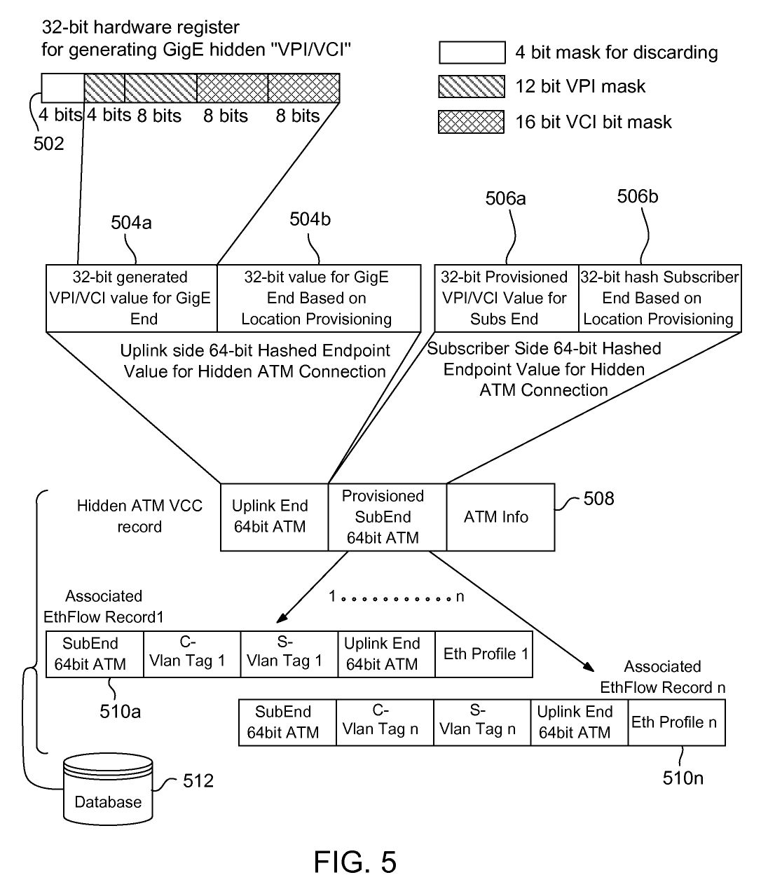

FIG. 5 depicts an example model for associating multiple Ethernet flows to a hidden ATM VCC, and is referred to in conjunction with flow provisioning process 300 (FIG. 3) continued below.

Referring to both FIGS. 3 and 5, if the validation check in block 306 passes, in block 310, a 32-bit value corresponding to the subscriber-side location provisioning data obtained in block 302 is internally hashed. The result is a 32-bit hashed value corresponding to the subscriber end based on its location provisioning 506b. The 32-bit hashed subscriber end value 506b is appended to a 32-bit value which includes the VPI/VCI value 506a which was entered during provisioning of subscriber-side information on the PON card 104 to generate a 64-bit hashed subscriber endpoint for the provisioned connection.

In block 312, the uplink side location provisioning obtained in block 302 is used to form another 32-bit value for the GigE endpoint 504b. Particularly, this information is the protection group (i.e., location) information for the uplink side (e.g., GigE uplink card 105).

In block 314 CPU 103 generates a unique hidden 32-bit VPI/VCI value for the GigE endpoint 504a. This is accomplished by first masking and extracting 28-bits of a 32-bit counter register 502. Particularly, the value of the 32-bit counter register 502 is masked by a 16-bit mask to form a hidden VCI. The value of the 32-bit counter register 502 also is masked by a 12-bit mask to generate a hidden VPI. The remaining bits are masked off by another mask (e.g., 4-bit mask) and discarded. The resulting 28-bit hidden VPI/VCI values are then hashed with a 4-bit connection type to make it a hashed 32-bit value. Other hashing values may be used to hash the 28-bit hidden VPI/VCI value in order to obtain the hashed 32-bit value. The result is a hashed 32-bit value including the generated VPI/VCI values. This hashed 32-bit value is used to convert the provisioned data into a database record in the same format as a typical VCC record, the difference being that this record is not visible in a listing of VCCs provisioned in the system. The non-visible record is referred to herein as a “hidden ATM VCC record.” Since the construction of a hidden VCC is compatible to a VCC that would have been normally provisioned in the ATM system, the software processing remains transparent of whether the VCC is a fully provisioned VCC record or from a hidden VCC record.

The 32-bit value for the GigE endpoint based on the location provisioning generated in block 312 (504b) is appended to the hashed 32-bit value including the generated VPI/VCI value 504a to generate an uplink side 64-bit hashed GigE endpoint identifier for the hidden ATM connection. Since the 64-bit hashed value is generated based on a moving 32-bit counter (i.e., an internal register), the probability that it is unique is high. The 32-bit counter may be provided by either hardware or software, or combination of both. Another time-based or other pseudo-random source can be used instead of, or in conjunction with, the 32-bit counter register 502 to generate the value of the hidden VPI/VCI value for the GigE endpoint. Collectively such registers, counters and number generators are each referred to as an internal register.

In block 316, both the 64-bit endpoint identifier for the uplink (e.g., GigE uplink card 105) side connection (504a, 504b) and the 64-bit identifier for the subscriber (e.g., PON card 104) side connection (506a, 506b) are stored in a hidden ATM VCC record 508. Additional ATM information for the ATM connection may also be stored in the hidden ATM VCC record. The hidden ATM VCC record 508 may be stored in a device such as a flash storage device in CPU 103 (not shown). As explained above, the record is referred to as a “hidden” record because the information provisioned in block 302 is stored in the database record with the same format as a typical ATM VCC record, but is not visible by a user through, for example, a listing of VCCs. It is not visible in the listing because the hidden record is filtered out by the user interface software based the endpoint information. Particularly, a determination is made whether the uplink endpoint is a GigE card, and if so, it is filtered.

In block 318, the 64-bit endpoint identifier for the uplink (e.g., GigE uplink card 105) side of the connection and the 64-bit identifier for the subscriber (e.g., PON card 104) side of the connection and Ethernet information obtained during user provisioning in block 302 (e.g., data entries 606-613 described below with respect to FIG. 6a) are stored in an Ethernet flow-data record 510a-510n. The Ethernet flow-data records 510-510n and the hidden ATM VCC records 508 are stored in database 512, which may implemented on a storage device in CPU 103.

Each of the Ethernet flow records 510a-510n is defined with the same 64-bit subscriber endpoint which is used to define a hidden ATM VCC record 508. Each Ethernet flow-record 510a-510n also holds the subscriber (or customer) virtual local area network identifier “C-VLAN Tag” and service or network side “S-VLAN Tag,” priority information and the traffic characteristics defined for each flow (Eth Profile 1-n). The binding of the 64-bit subscriber endpoint with the C-VLAN and S-VLAN tags forms a unique key for each of the Ethernet flow data records 510a-510n. This unique key is used in conjunction with the hashed 64-bit uplink endpoint value containing the generated VPI/VCI to identify and associate multiple Ethernet flows on a single hidden VCC.

At block 320, adding the hidden ATM VCC record to the database 512 triggers a message notification to an ATM connection setup task in the CPU 103. The connection setup task will add an ATM VCC connection entry corresponding to the hidden VCC to its VCC connection table which resides in a storage device such as RAM. This table also contains normal VCCs that are provisioned on non-GigE ATM uplinks in the system. The added entry includes the 64-bit connection endpoints and other internal data such as connection state, traffic profiles and the like, required for setting up traffic flow across the ATM backplane between the uplink and the subscriber. This data is sent from the CPU 103 to the particular cards involved in the connection path during connection setup.

The structure of a VCC connection table entry for an ATM Ethernet connection provisioned on a GigE uplink card has the same VCC endpoints as in the Ethernet flow record added to the flash database 512. Database search routines can identify the Ethernet flow records corresponding to a VCC from the common 64-bit subscriber endpoint for an ATM VCC entry.

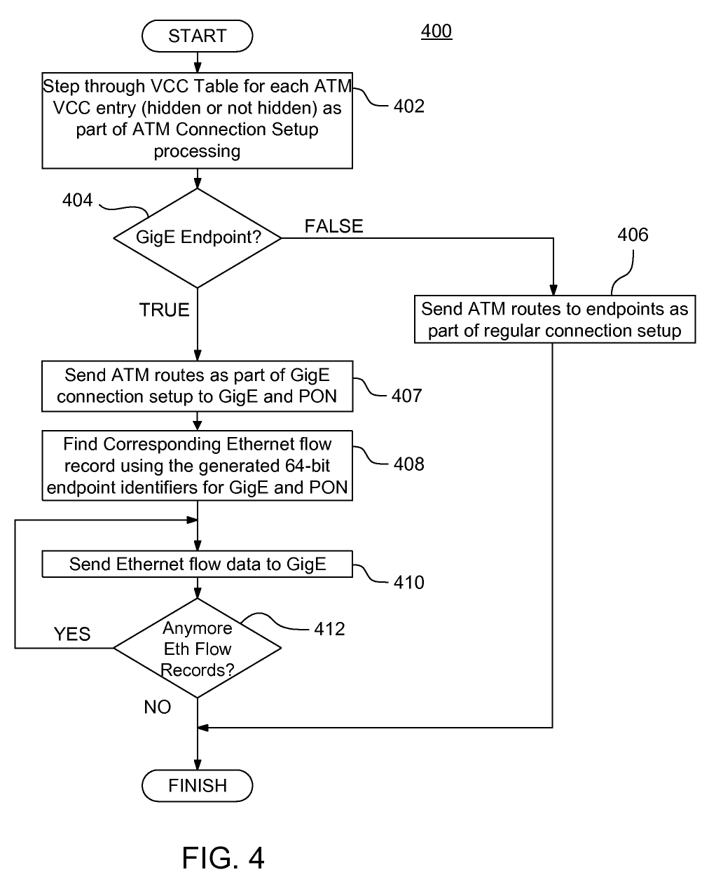

FIG. 4 depicts a process 400 for setting up an ATM connection in accordance with an example embodiment of the present invention. Process 400 may be executed and scheduled by CPU 103. In block 402, an ATM connection manager task processes each entry of the VCC table as part of a typical VCC setup process or as part of a connection setup audit. Since the construction of a VCC discussed above with respect to process 300 (FIG. 3) is compatible to a VCC that would have been normally provisioned in the ATM system, the software processing remains transparent of whether the VCC is a fully provisioned VCC record or from a hidden VCC record. At block 404, each VCC entry being processed is examined and a determination is made based on the associated protection group value as to whether the entry corresponds to a GigE endpoint.

If a determination is made at block 404 that the VCC endpoint is a GigE endpoint, then at block 407 the ATM routes are sent to the GigE uplink card 105 and PON card 104 to establish an ATM backplane connection. At block 408, the corresponding Ethernet flow record for the GigE uplink card 105 is located. The Ethernet flow record is located using the 64-bit endpoint identifiers for the GigE uplink card 105 and PON card 104 generated during the provisioning described above with respect to FIG. 3. In turn, the Ethernet flow data is sent to the GigE uplink card 105, as shown in block 410. If a determination is made at block 404 that the VCC endpoint is not a GigE endpoint, then at block 406, ATM routes corresponding to the connection are sent to the endpoints as part of a conventional ATM connection setup.

At block 412, a determination is made whether any more Ethernet flows matching the hidden ATM VCC entry (located in block 402) exist. If so, then the additional Ethernet flow data is sent to the GigE uplink card 105, as shown in block 410. This occurs until no more Ethernet flows matching the hidden ATM VCC connection entry are found.

Referring to FIG. 6a, interface 600a depicts a user interface for provisioning an ATM Ethernet connection in accordance with an example embodiment of the present invention. Information collected via the user interface includes, for example, a connection type (601). The connection type entry (601) “group-group” represents the type of endpoints provisioned in a connection, which in this example is an ATM Ethernet connection between a GigE uplink group and a PON subscriber group. It should be understood that the entry naming conventions used herein are a design choice. Other naming conventions may be used to describe the types of entries used for provisioning.

Subscriber location (602) “LET-G1-1” represents the protection group for an ATM device such as PON card 104. VPI and VCI for the subscriber endpoints (603, 604) are the VPI and VCI discussed above in the description of provisioning with respect to FIGS. 3 and 5. In this example VPI and VCI are 1 and 32, respectively. ATM traffic profile number (605) is selected by the user and is used to apply an ATM class of service to the hidden ATM VCC record. The profile number (e.g., “2”) maps to an ATM class of service to apply the specified class of service to the hidden ATM VCC. For example the class of service may be as Unspecified Bit Rate (UBR), Constant Bit Rate (CBR), Real-time VBR(rt-VBR) or non-RealtimeVBR (nrtVBR).

Once the PON subscriber endpoint information is collected, the user is prompted for the Ethernet data associated with the connection, examples of which are shown in entries 606 through 613. These entries are values that are applied to the Ethernet flow record to forward traffic through the Ethernet connection. Field 606 prompts the user to specify the ATM Adaptation Layer 5 (“AAL5”) encapsulation type (e.g., “LLC”), which in the example shown in FIG. 6a is an LLC bridge for transport of ATM data over the Ethernet connection. Entry 607 prompts the user to enter a network location representing the GigE protection group (e.g., “let-G12-1”). Entry 608, ATM Ethernet Connection (“AEC”) classification type, specifies the connection between the GigE uplink card 105 and ATM endpoint (e.g., PON or DSL cards, 106, 206, respectively). More particularly, AEC classification type 608 specifies the VLAN tagging expected on frames to and from the subscriber, which in this example is a “subscriber VLAN tag” and indicates that the incoming Ethernet frames will have a C-VLAN Id and priority associated with it. The classification type could also be specified on other flows on the same port as untagged and priority tagged. Based on the choice of connection classification type, the user is prompted to enter the subscriber (or customer) virtual local area network identifier “C-VLAN Id” (609) and network side, network (or service) virtual local area network identifier “S-VLAN Id” (610).

The first traffic management rule identifier (611) and second traffic management rule identifier (612) collect traffic management rules which specify how to perform VLAN tagging operations on the Ethernet frames going across the connection. This allows the user to specify how the VLAN Tag and priority are mapped between the subscriber and network side. Entries 611 and 612 also specify, for example, whether to retain the VLAN tag or to modify it in the upstream or downstream direction. A packet traffic descriptor (613) entry specifies, for example, how the Ethernet flow will be rate-limited.

At line 614, the CPU 103 has sufficient information about the two endpoints in the connection. CPU 103 then determines whether the current flash database contains entries matching the 64-bit endpoints being added. If a determination is made that no matching entries exist, CPU 103 accepts the connections. Otherwise, CPU 103 issues a warning that the current connection may get over-written. In the example depicted in FIGS. 6a-6c, no existing entry is found, so the CPU can add the provisioned connection into the flash database as a new entry. At line 616, the user is provided with an opportunity to confirm that the entry is to be added to the flash database. Another option is to abort and start over.

If the user confirms the provisioning, CPU 103 stores the hidden VCC record and the associated Ethernet flow record into the database 512 (FIG. 5) and displays the provisioned information once again, as shown in lines 616-617, where line 616 shows the Ethernet parameters provisioned and 617 shows the connection endpoint information. At line 618 CPU 103 prompts for any additional Ethernet flows that the user may want to attach to the subscriber port.

FIG. 6B depicts a screen shot 600b showing example provisioning entries for second flow on the same port for a different subscriber VLAN-Id. This allows the user the ability to associate further flows to the same PON subscriber port. Thus, a unique subscriber VLAN tag on the port allows the CPU to attach multiple Ethernet flows to an internal ATM VCC without the user being aware of the presence of the VCC. For each unique Ethernet flow that the user adds on the same subscriber port, the CPU adds a new Ethernet flow record while keeping intact the hidden VCC record added previously. The entries are the same as those described above with respect to FIG. 6a and thus need not be described again.

FIG. 6C depicts another user interface screenshot 600c, which allows a user to list the ATM Ethernet connections provisioned, based on the protection group location. Particularly, entries 619 allow a user to enter the connection type and starting and ending protection groups. Based on this information, lines 620 and 621 display the listing of the ATM Ethernet connections.

It should be understood that the above provisioning is an example, and not indicative of required provisioning entries.

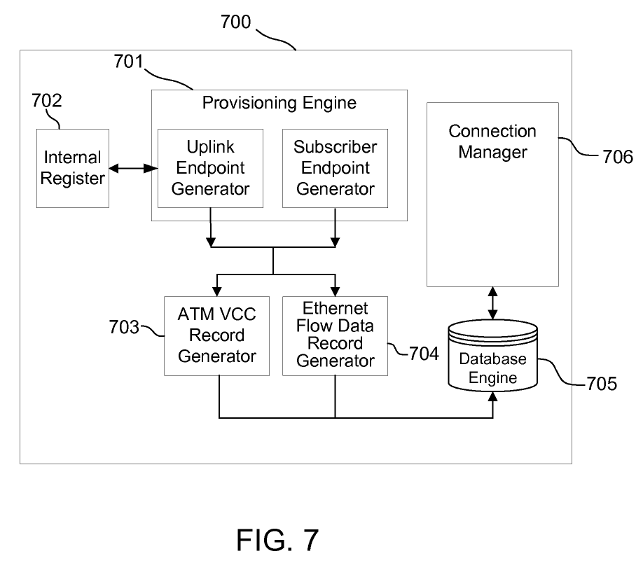

FIG. 7 is a collaboration diagram 700 of functional modules deployed on a computer system for associating multiple Ethernet flows to an ATM VCC in accordance with an example embodiment of the present invention. The functional modules include a provisioning engine 700, an ATM VCC record generator 703, an Ethernet flow data record generator 704 and a connection manager 706. The functional modules may be implemented on CPU card 103 as software modules or objects. In other embodiments, the functional modules may be implemented using hardcoded computational modules or other types of circuitry, or a combination of software and circuitry modules.

Provisioning engine 701 provisions the GigE uplink card 103 (FIG. 1) and the PON card 104 into an ATM Ethernet connection. As described above with respect to FIG. 3, block 302 and 304, this may be performed by entering information about GigE uplink card 105 and PON card 104 through a front end, user interface (not shown). The provisioning engine reads the provisioning information and collects the physical endpoint information entered by an operator to setup a connection between the GigE uplink card 105 and the Ethernet port of ONT 106. This physical endpoint information contains the location information used by the provisioning engine's uplink endpoint generator to generate the GigE uplink endpoint and the provisioning engine's subscriber endpoint generator to generate the subscriber endpoint.

Provisioning engine 701 also validates whether the physical endpoints correspond to valid endpoint cards, as describe above with respect to FIG. 3, blocks 306, 308.

The Subscriber endpoint generator internally hashes the subscriber side location provisioning data and appends the resulting 32-bit value to another 32-bit value including the VPI/VCI value 506a (FIG. 5) previously entered to provision the subscriber-side information on the PON card. Together, these 32-bit values create a 64-bit hashed subscriber endpoint for the provisioned connection as described above with respect to FIG. 3, block 310.

The uplink endpoint generator of provisioning engine 701 uses the uplink side location provisioning obtained to form another 32-bit value for the GigE endpoint, as described above with respect to FIG. 3, block 312. Together with the internal register 702, the uplink endpoint generator generates a unique hidden 32-bit VPI/VCI value for the GigE endpoint and appends this value to the hashed 32-bit value including the generated VPI/VCI value. The result creates an uplink side 64-bit hashed GigE endpoint identifier for the hidden ATM connection, as described above with respect to FIG. 3, block 314.

The ATM VCC record generator performs block 316 (FIG. 3) to store both the 64-bit endpoint identifier for the uplink (e.g., GigE uplink card 105) side connection (504a, 504b) and the 64-bit identifier for the subscriber (e.g., PON card 104) side connection (506a, 506b) in a hidden ATM VCC record 508 in the database engine 705.

The Ethernet flow data record generator 704 performs blocks 318 (FIG. 3) to store the 64-bit endpoint identifier for the uplink (e.g., GigE uplink card 105) side of the connection, the 64-bit identifier for the subscriber (e.g., PON card 104) side of the connection and Ethernet information in an Ethernet flow-data record 510a-510n (FIG. 5) in the database engine 705. Provisioning engine 701 also stores a hidden ATM VCC entry in the database engine 705 as per FIG. 3, block 320.

The connection manager 706, sets up an ATM connection as per process 400 (FIG. 4), by processing each entry of the VCC table. Particularly, connection manager 706, examines each VCC entry and determines whether the entry corresponds to a GigE endpoint. If the VCC endpoint is a GigE endpoint, then connection manager 706 sends ATM routes to the GigE uplink card 105 and PON card 104 to establish an ATM backplane connection. The corresponding Ethernet flow record for the GigE uplink card 105 is located using the 64-bit endpoint identifiers for the GigE uplink card 105 and PON card 104 generated during the provisioning, and Ethernet flow data is sent to the GigE uplink card 105. If the VCC endpoint is not a GigE endpoint, then the connection manager sends the ATM routes corresponding to the connection to the endpoints as part of a conventional ATM connection setup.

Connection manager 706 also determines whether any more Ethernet flows matching the hidden ATM VCC entry exist. If so, then it sends the additional Ethernet flow data to the GigE uplink card 105 until no more Ethernet flows matching the hidden ATM VCC connection entry are found.

The example embodiments of the invention (i.e., systems 100, 200, processes 300, 400 or any part(s) or function(s) thereof) may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU 103 typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU 103 typically includes software resident on a storage media (e.g., a disk drive or memory card), which, when executed, directs the CPU 103 in performing transmission and reception functions. The CPU software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

Although for convenience CPU 103 is shown as being a single CPU, in other example embodiments CPU 103 may include plural separate CPUs, wherein each is dedicated to a separate application, such as, for example, a data application, a voice application, and a video application.

Software embodiments of the example embodiments presented herein may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the FIGS. 1-6 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the processes recited in the claims need not be performed in the order presented.

What is claimed is:

1. A system for associating one or more Ethernet flows to an ATM VCC, comprising:
a processor configured to generate an ATM VCC record having a first endpoint identifier corresponding to a subscriber device and a second endpoint identifier corresponding to a transceiver card.

2. The system according to claim 1, wherein the processor is further configured to use at least an internal register to generate the second endpoint identifier.

3. The system according to claim 2, wherein the processor is further configured to use the internal register to generate a hidden VPI/VCI value.

4. The system according to claim 3, wherein the processor is further configured to hash the hidden VPI/VCI value with user provisioning data to generate the second endpoint identifier.

5. The system according to claim 1, wherein the processor is further configured to generate an Ethernet flow data record comprising the first endpoint identifier, the second endpoint identifier and user provisioning data.

6. The system according to claim 1, wherein the processor is further configured to create a hidden ATM VCC entry in an ATM connection table based on the first endpoint identifier and the second endpoint identifier.

7. The system according to claim 5, wherein the processor is further configured to send an ATM route as part of an Ethernet device connection setup to the Ethernet device and the subscriber device, locate the Ethernet flow data record using the first and second endpoint identifiers, and communicate Ethernet flow data to the transceiver card.

8. The system according to claim 1, wherein the transceiver card is a GigE card.

9. The system according to claim 1, wherein the subscriber device is at least one of a transceiver card, an ONT, a PON card and a DSL card.

10. A method for associating one or more Ethernet flows to an ATM VCC, comprising:
generating an ATM VCC record having a first endpoint identifier corresponding to a subscriber device and a second endpoint identifier corresponding to a transceiver card.

11. The method according to claim 10, wherein the second endpoint identifier is based on at least an internal register.

12. The method according to claim 11, further comprising:
generating a hidden VPI/VCI value using the internal register.

13. The method according to claim 12, further comprising:
hashing the hidden VPI/VCI value with user provisioning data to generate the second endpoint identifier.

14. The method according to claim 10, further comprising:
generating an Ethernet flow data record comprising the first endpoint identifier, the second endpoint identifier and user provisioning data.

15. The method according to claim 10, further comprising:
creating a hidden ATM VCC entry in an ATM connection table based on the first endpoint identifier and the second endpoint identifier.

16. The method according to claim 14, further comprising:
sending an ATM route as part of an Ethernet device connection setup to the transceiver card and the subscriber device;
locating the Ethernet flow data record using the first and second endpoint identifiers; and
communicating Ethernet flow data to the transceiver card.

17. The method according to claim 10, wherein the transceiver card is a GigE card.

18. The method according to claim 10, wherein the subscriber device is at least one of a transceiver card, an ONT, a PON card and a DSL card.

19. A computer program product comprising a computer usable medium having control logic stored therein for associating one or more Ethernet flows to an ATM VCC, the control logic comprising:
computer readable program code to generate an ATM VCC record having a first endpoint identifier corresponding to a subscriber device and a second endpoint identifier corresponding to a transceiver card.

20. The computer program product according to claim 19, wherein the second endpoint identifier is based on at least an internal register.

21. The computer program product according to claim 20, the control logic further comprising computer readable program code to generate a hidden VPI/VCI value using the internal register.

22. The computer program product according to claim 21, the control logic further comprising computer readable program code to hash the hidden VPI/VCI value with user provisioning data to generate the second endpoint identifier.

23. The computer program product according to claim 19, the control logic further comprising computer readable program code to generate an Ethernet flow data record comprising the first endpoint identifier, the second endpoint identifier and user provisioning data.

24. The computer program product according to claim 19, the control logic further comprising computer readable program code to create a hidden ATM VCC entry in an ATM connection table based on the first endpoint identifier and the second endpoint identifier.

25. The computer program product according to claim 23, the control logic further comprising:
computer readable program code to send an ATM route as part of an Ethernet device connection setup to the transceiver card and the subscriber device;
computer readable program code to locate the Ethernet flow data record using the first and second endpoint identifiers; and
computer readable program code to communicate Ethernet flow data to the transceiver card.

26. The method according to claim 19, wherein the transceiver card is a GigE card.

27. The method according to claim 19, wherein the subscriber device is at least one of a transceiver card, an ONT, a PON card and a DSL card.
